(19) United States
(12) Patent Application Publication
(10) Pub. No.: US 2025/0065764 A1
(43) Pub. Date: Feb. 27, 2025

(54) ELECTRIC VEHICLE CHARGING SYSTEM

(71) Applicant: Danlaw, Inc., Novi, MI (US)

(72) Inventors: Louis Scott Bolt, Brighton, MI (US); Eugenijus Sumskas, Novi, MI (US); Tim Morris, Plymouth, MI (US)

(73) Assignee: Danlaw, Inc., Novi, MI (US)

(21) Appl. No.: 18/800,604

(22) Filed: Aug. 12, 2024

Related U.S. Application Data
(60) Provisional application No. 63/578,366, filed on Aug. 23, 2023.

(51) Int. Cl. B60L 53/66; B60L 53/30; B60L 53/65; B60L 53/67; B60L 58/12

(52) U.S. Cl. CPC B60L 53/665; B60L 53/305; B60L 53/65; B60L 53/67; B60L 58/12; B60L 2240/80

(57) ABSTRACT

A method for operating a vehicle charging system includes providing data from an electric vehicle through a wireless communications device removably installed in the electric vehicle. The method also includes wirelessly receiving the data by an electric vehicle charger. Additionally, the method involves managing, by the electric vehicle charger and using the data, provision of charging current from the electric vehicle charger for traction batteries of the electric vehicle.

### CROSS REFERENCE TO RELATED APPLICATIONS

This application claims the benefit of priority to U.S. Provisional Patent Application No. 63/578,366, filed Aug. 23, 2023, which is hereby incorporated by reference in its entirety.

### INTRODUCTION

This disclosure is in the field of electric vehicle charging.

An electric vehicle may be charged using an offboard charger known as electric vehicle supply equipment (EVSE). EVSE manages the supply of alternating current (AC) electric power to electric vehicles. An electric vehicle may, in turn, have an onboard charger that rectifies the AC electric power and manages the charging of the traction batteries in the electric vehicle.

Transfer of AC electric power between EVSE and an electric vehicle may be supervised and accomplished according to a standard known as Society of Automotive Engineers Recommended Practice J1772 (“SAE J1772”). Charging according to SAE J1772 acts to provide charge current as well as to exchange certain information between EVSE and an electric vehicle, such as the amount of charge current that the EVSE can provide and whether the electric vehicle is able to accept charge. As such, charging according to SAE J1772 may be generally effective. A related standard, North American Charging Standard (“NACS”), is used in the charging of certain electric vehicles as well. However, making charging more intelligent by providing additional information about the vehicle and about the charging process may provide advantages in charging an electric vehicle.

### SUMMARY

A method for operating a vehicle charging system includes providing data from an electric vehicle through a wireless communications device removably installed in the electric vehicle, wirelessly receiving the data by an electric vehicle charger, and managing, by the electric vehicle charger and using the data, provision of charging current from the electric vehicle charger for traction batteries of the electric vehicle. The wireless communications device may be removably installed in a diagnostic connector of the electric vehicle, including a diagnostic connector of the electric vehicle that is compliant with SAE Recommended Practice J1962.

As an enhancement, the data may include identification information that uniquely identifies the electric vehicle, and managing provision of charging current from the electric vehicle charger for traction batteries of the electric vehicle may include using the identification information to authorize charging of the electric vehicle. As further enhancements, the method for operating a vehicle charging system may include storing the data in nonvolatile memory of the wireless communications device, and the data may include state of charge of the traction batteries or range of the electric vehicle currently available from stored electrical energy in the traction batteries.

In the method for operating a vehicle charging system, managing provision of charging current from the electric vehicle charger for traction batteries of the electric vehicle may include providing charging current to the electric vehicle to reach a threshold level of charge or threshold electric vehicle driving range in the traction batteries by a deadline provided by a user of the electric vehicle. This may further be accomplished in view of time-variable electric rates of an electric utility supplying electric power to the charger.

The method for operating a vehicle charging system may also include providing, by the wireless communications device, a unique identifier of the wireless communications device to the electric vehicle charger and enabling charging current to be provided from the electric vehicle charger only if the wireless communications device is authorized to use the electric vehicle charger.

The method may also include wirelessly sensing the proximity of the wireless communications device to the electric vehicle charger and seeking charging instructions from a user of the electric vehicle if the electric vehicle approaches more closely than a predetermined distance to the electric vehicle charger.

An alternative method for operating a vehicle charging system includes providing first data from a first electric vehicle through a first wireless communications device removably installed in the first electric vehicle and providing second data from a second electric vehicle through a second wireless communications device removably installed in the second electric vehicle. The method additionally includes wirelessly receiving the first data by a first electric vehicle charger and wirelessly receiving the second data by a second electric vehicle charger. Further, the method includes managing, by the first electric vehicle charger and the second electric vehicle charger and using the first data and second data, provision of charging current for first traction batteries of the first electric vehicle and second traction batteries of the second electric vehicle.

The alternative method for operating a vehicle charging system may further include managing a total charging current from the first electric vehicle charger and the second electric vehicle charger so that the total charging current does not exceed a capacity of an electrical service supplying both the first electric vehicle charger and the second electric vehicle charger.

The alternative method for operating a vehicle charging system may additionally involve assuring that the traction batteries of the first electric vehicle have at least a threshold level of charge or a threshold electric vehicle driving range before charging the traction batteries of the second electric vehicle. Alternatively, the method may include assuring that the first traction batteries have at least a first threshold level of charge or a first threshold electric vehicle driving range and the second traction batteries have at least a second threshold level of charge or a second threshold electric vehicle driving range and, thereafter, prioritizing charging the first traction batteries to at least a third threshold level of charge level or third threshold electric vehicle driving range before charging the second traction batteries.

An electric vehicle charging system includes one or more controllers collectively programmed with the following instructions: provide data from the electric vehicle through a wireless communications device installed in the electric vehicle; wirelessly receive the data by an electric vehicle charger; and manage, by the electric vehicle charger and using the data, provision of charging current from the electric vehicle charger for traction batteries of the electric vehicle.

In the electric vehicle charging system, the one or more controllers may be further collectively programmed to provide second data from a second electric vehicle through a second wireless communications device installed in the second electric vehicle, to wirelessly receive the second data by a second electric vehicle charger, and to manage, by the electric vehicle charger and the second electric vehicle charger and using the data and the second data, provision of charging current for the traction batteries of the electric vehicle and for second traction batteries of the second electric vehicle. Additionally or alternatively, the one or more controllers may be collectively programmed to charge the first electric vehicle and the second electric vehicle each to a respective threshold level of state of charge or vehicle driving range and, thereafter, continue to charge the first electric vehicle.

The one or more controllers may further be collectively programmed to infer a relationship between driving range of an electric vehicle and state of charge of the traction batteries of the electric vehicle based on past charging experience of the electric vehicle.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 is a block diagram of an electric vehicle charging system.

FIG. 2 is an illustration of a dongle from the electric vehicle charging system of FIG. 1.

FIG. 3 is an electrical block diagram of the dongle of FIG. 2.

FIG. 4 is an electrical block diagram of the charger of FIG. 1.

FIG. 5 is a block diagram showing a multi-vehicle charging scenario.

FIG. 6 is a block diagram of a DC or a bidirectional charger.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

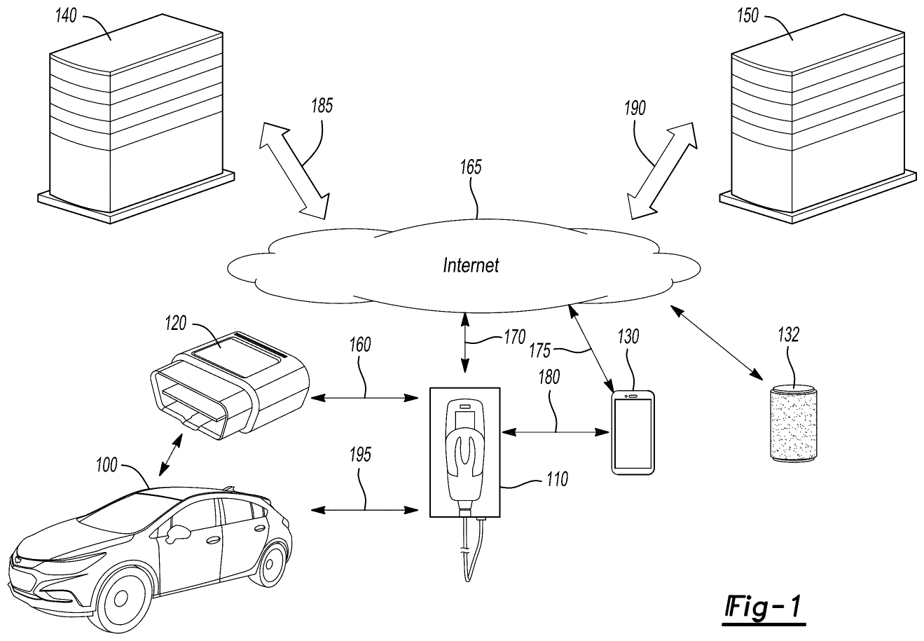

Referring first to FIG. 1, a system for recharging an electric vehicle 100 is illustrated. Electric vehicle 100 may be a battery-electric vehicle (BEV), a vehicle whose propulsion is fully electric using electrical energy stored in traction batteries. Electric vehicle 100 may also be a hybrid-electric vehicle (such as a plug-in hybrid-electric vehicle) that uses electrical energy stored in traction batteries for part of its propulsion requirements. Furthermore, electric vehicle 100 may be a car, SUV, truck, van, off-road vehicle, motorcycle, bicycle, scooter or any other type or style of vehicle whose propulsion is powered, at least in part, by electrical energy stored onboard the vehicle.

The system also includes a charger 110 that may be electric vehicle supply equipment (EVSE). The system further includes a dongle 120 that may be removably connected with the electrical system of electric vehicle 100. The system may also include a mobile communications device such as smartphone 130 and may also include a smart voice operated Internet interface device 132, such as “Alexa” provided by Amazon, or similar devices provided by other suppliers. Smart voice operated Internet interface device 132 may substitute for interface via smartphone 130 using voice commands. The system may also include a back office server 140, which may be associated with charger 110, and a power company server 150 associated with the electric power utility.

Charger 110 may communicate with dongle 120 via wireless communication channel 160. Wireless communication channel 160 may be via Bluetooth technology, a short-range wireless radiofrequency technology that is suitable for the typical distance between electric vehicle 100 and charger 110 when electric vehicle 100 is near charger 110 and/or being charged by charger 110. Communication between charger 110 and the Internet (or the “cloud”) 165 may be by communication channel 170, which may be via WiFi, cellular data communication, or hardwired Internet connection. Such communication on communication channel 170 may be by the so-called Open Charge Point Protocol (OCPP), an application protocol for communication between electric vehicle charging stations and systems that manage such charging stations.

Communication between smartphone 130 and the Internet 165 may be by wireless channel 175, which may be via WiFi or cellular data communications. Further, to the extent that smartphone 130 is near charger 110, communication between smartphone 130 and charger 110 may be by wireless communication channel 180, which may be Bluetooth technology. Wireless communication channel 180 may alternatively or additionally be provided by WiFi, cellular communication, or other suitable channels. Back office server 140 is connected to Internet 165 via communication channel 185; communication on this channel may be by OCPP. Power company server 150 may be connected to Internet 165 via communication channel 190; communication on this channel may be by OpenADR, an open standard protocol for communication between power utilities and vehicle charger clients. Interconnection between electric vehicle 100 and charger 110 may be by channel 195. Channel 195 may be according to Society of Automotive Engineers (SAE) recommended practice J1772, which provides specifications for both the circuitry and connectors over which charge current is provided by EVSE to an electric vehicle under charge and also provides specifications for certain control signals that oversee and control transfer of charge current to the vehicle. For instance, a control pilot signal (CP), which may be a square wave, may be provided by charger 110, the duty cycle of which signal may indicate the amount of charge current available from charger 110. Under SAE J1772, electric vehicle 100 may then load the signal, reducing its amplitude, to confirm that electric vehicle 100 can accept charge. While the control pilot signal according to SAE J1772 is generally effective to supervise charging of an electric vehicle such as electric vehicle 100, the CP signal is of relatively limited utility relative to other information that may be available about electric vehicle 100 and that may enhance the charging of electric vehicle 100.

Rather than being according to SAE J1772, channel 195 may be by NACS, a generally similar charging interface used by Tesla-brand vehicles, or by other charging interfaces.

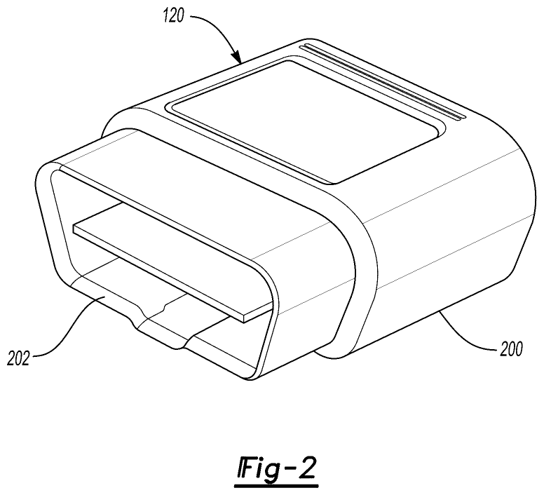

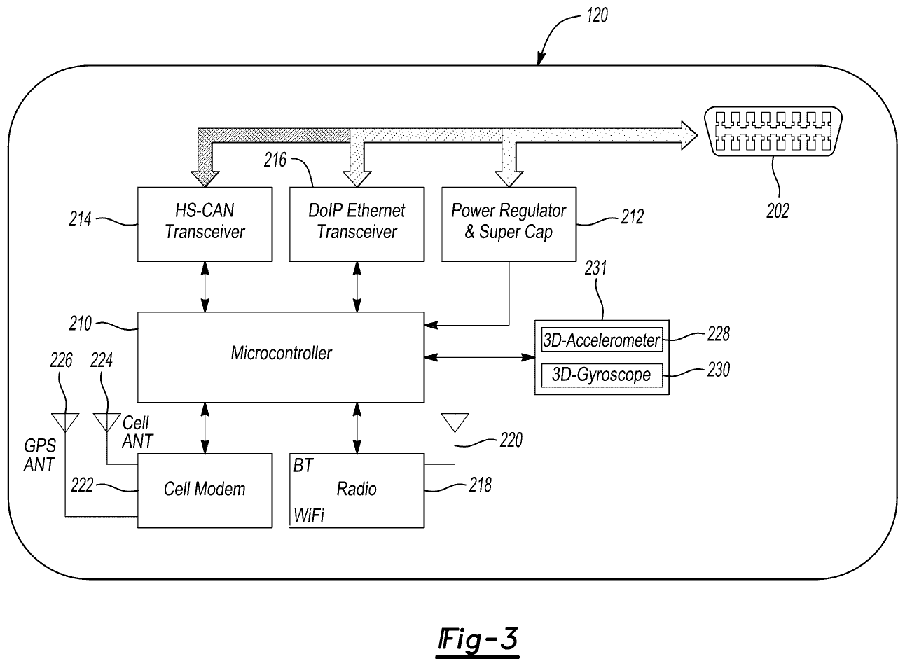

Dongle 120 is described in more detail with respect to FIG. 2 and FIG. 3. Dongle 120 includes a case 200 that may be of resilient plastic or another suitable material to protect the electronics within dongle 120. Dongle 120 further includes an electrical connector 202. Electrical connector 202 may be adapted for removable connection with the electrical system of electric vehicle 100. This connection may be to a diagnostic connector of electric vehicle 100, which may be a connector according to one or more versions of SAE recommended practice SAE J1962. Electrical connector 202 is compatible with a respective vehicle-side mating connector within electric vehicle 100. The vehicle-side mating connector within electric vehicle 100 may be hardwired into the electrical system of electric vehicle 100.

Dongle 120 may be controller that is a microprocessor-based device containing a microcontroller 210. Dongle 120 may also contain a power regulator 212, which regulates and conditions power provided for operation of dongle 120 by electric vehicle 100 via the vehicle-side mating connector with which electrical connector 202 of dongle 120 mates when dongle 120 is connected to the electrical system of electric vehicle 100.

Microcontroller 210 may be electrically coupled with a controller area network (CAN) bus transceiver 214. CAN bus transceiver 214 may be adapted to communicate via one or more versions of CAN that may be present on electric vehicle 100, such as high-speed CAN (HS-CAN). Microcontroller 210 may also be electrically coupled with an Ethernet transceiver 216. Ethernet transceiver 216 may be adapted to communicate over various Ethernet protocols such as Diagnostics Over IP (DoIP). Ethernet transceiver 216 communicates over protocols that are present on electric vehicle 100 and appropriate to provide the functionality described in this disclosure.

Dongle 120 may also contain a radio 218 that may communicate via Bluetooth (BT) short-range communications technology and/or WiFi. One or more antennas 220, appropriate for the respective communication taking place via radio 218, are provided in dongle 120 as well.

Dongle 120 may also contain a cellular communications modem 222, along with an appropriate antenna 224 for cellular communications. Cellular communications modem 222 may also be adapted for global positioning system (GPS) functionality and provided with an appropriate antenna 226. Dongle 120 may also have provision for insertion of a subscriber identity module (SIM) card, which provides the identity for dongle 120 as a cellular communications device.

Dongle 120 may further include an accelerometer 228 which may be a three-dimensional accelerometer to measure acceleration of electric vehicle 100 in three dimensions and/or a gyroscope 230, which may be a three-dimensional gyroscope to measure angular velocity of electric vehicle 100 in three dimensions. Accelerometer 228 and gyroscope 230 may be provided in a common integrated circuit package 231.

It is to be understood that dongle 120 contains sufficient electronic resources (microcontroller, memory, software, inputs, outputs, peripherals, and the like) in order to perform the functions ascribed to dongle 120 in this disclosure.

As described, dongle 120 may be removably installed in electric vehicle 100, namely in this case removably inserted or removably installed into a vehicle-side connector that is itself hardwired into the electrical system of electric vehicle 100. The functions of dongle 120 may also be included in a controller or module, such as a telecommunications control unit (TCU), that itself is hardwired into the electrical system of electric vehicle 100. The TCU may have cellular communications capability as well as WiFi and short-range communications capability.

Back office server 140 (FIG. 1) may operate to administer charger 110, such as by providing software updates as needed, monitoring charger 110 for proper ongoing operation, and acquiring data about operation of charger 110. Back office server 140 may also collect data regarding the charging events for specific vehicles and may report such data back to the owners of the vehicles such as, via smartphone 130. Back office server 140 may be operated by the company/entity that owns or provides service via charger 110.

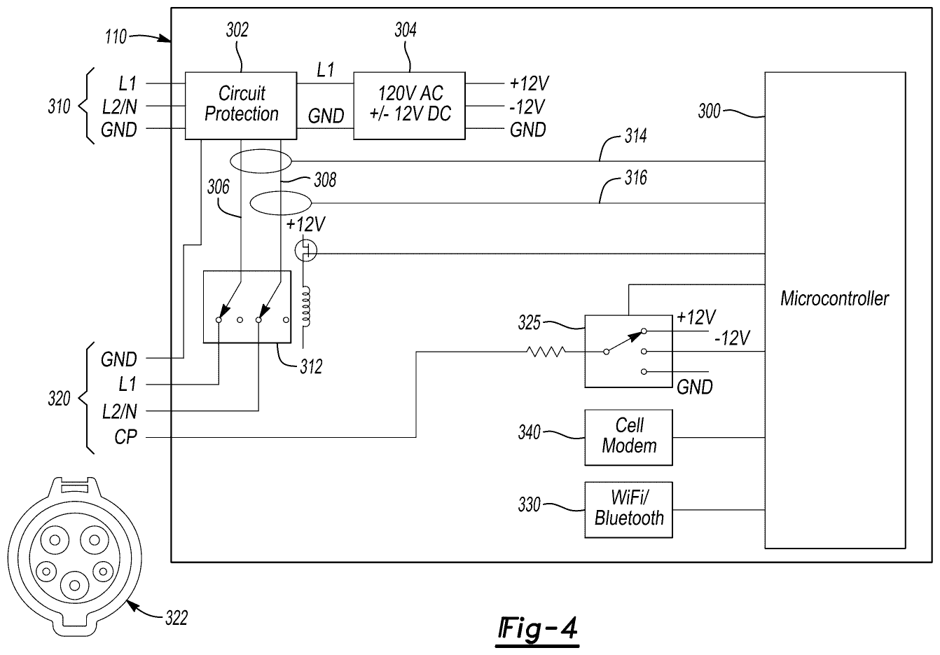

Charger 110 will now be described in more detail with reference to FIG. 4. As discussed, charger 110 may be EVSE designed to provide AC charge current to an onboard charger on electric vehicle 100 for charging the traction batteries of electric vehicle 100. Charger 110 may be a microprocessor-based device and is understood to have sufficient electronic resources (microprocessor, memory, software, inputs, outputs, peripherals, and the like) to perform the functions ascribed to charger 110 herein. Charger 110 may include microcontroller 300. Charger 110 may also include inputs 310 for connection to an electrical energy source for charging the traction batteries of electric vehicle 100. Charger 110 may be a “Level 2” device, with inputs 310 being from a nominal 240-volt AC source across circuits L1 and L2 of inputs 310. Charger 110 may also be a “Level 1” device, with inputs 310 being from a nominal 120-volt AC source with circuit L2 of inputs 310 instead being a Neutral circuit and the potential between circuits L1 and N of inputs 310 being nominally 120 volts AC. Circuit protection 302 may protect charger 110 from transients, overvoltage, and other electric system abnormalities. Power supply 304 may then downconvert and rectify the AC voltage and provides DC output, say, at 12 volts, for operation of the lower-voltage electrical and electronic components within charger 110.

Also provided as outputs of circuit protection 302 are charging circuit 306 and charging circuit 308 for provision of AC charging current from charger 110 to the onboard charger on electric vehicle 100. Charging circuits 306 and 308 may be controlled by a contactor 312 that is in turn controlled by microcontroller 300 to turn charging current on and off under appropriate circumstances. One such circumstance may be whether or not electric vehicle 100 and/or dongle 120 is recognized as authorized for charging through charger 110, with contactor 312 remaining in an open state in the case of lack of authorization of electric vehicle 100 or dongle 120. Through circuit 314 and circuit 316, microcontroller 300 monitors the current on circuit 306 and circuit 308.

Provided as outputs 320 from charger 110 are charging circuits 306 (as L1) and 308 (as L2/N), a ground circuit (GND) and a control pilot (CP). (“L2/N” would be a line voltage (“L2”) in the case of a Level 2 charger 110 operating at 240V AC and a neutral (“N”) in the case of a Level 1 charger 110 operating at 120V AC.) CP may be a pulse-width modulated signal provided via relay 325 that is used according to SAE Recommended Practice J1772 in order to supervise the charging of an electric vehicle such as electric vehicle 100. For instance, charger 110 may generate a pulse width modulated square wave on the CP circuit, the duty cycle of which may indicate the amount of charge current that charger 110 can provide. In turn, electric vehicle 100 may load down the square wave's voltage amplitude to indicate that electric vehicle 100 can accept charge current. Outputs 320 may be provided via a connector 322, which may be a connector according to SAEJ1772.

Charger 110 may also include a WiFi and/or Bluetooth radio 330 to allow charger 110 to communicate via Bluetooth technology and/or WiFi. Charger 110 may also include a cellular telecommunications modem 340 to allow charger 110 to engage in cellular telecommunications, including cellular data telecommunications with the Internet/cloud.

Certain data may be available on respective data buses on electric vehicle 100 and thus available to dongle 120 via connector 202. Some of the data may be government-legislated, say, through SAE J1979, and other data may also be available as well. The data that may be available to dongle 120 may include the following:

Vehicle Identification Number (VIN) of electric vehicle 100
Capacity of traction batteries of electric vehicle 100, e.g., in units of
energy (e.g., kilowatt-hours) or units of stored charge (e.g., amp-hours)
State of health of traction batteries of electric vehicle 100
State of charge of traction batteries of electric vehicle 100 e.g.,
in % of full charge or in units of energy currently stored (e.g.,
kilowatt-hours) or units of charge currently stored (e.g., amp-hours)
Odometer of electric vehicle 100
Closed/open state of windows of electric vehicle 100
Locked/unlocked state of doors of electric vehicle 100
Distance (range) until the traction batteries of electric vehicle
100 will be depleted
Diagnostic trouble codes (DTCs) reported by various electronic
controllers on electric vehicle 100
Charging capacity (e.g., 4 kW, 8 kW, 11 kW) of the onboard charger
in electric vehicle 100

The above data may be accessed periodically or continuously by dongle 120. Any or all of the data may also be saved locally within nonvolatile memory of dongle 120, in the event that the data buses on electric vehicle 100 enter a state where communications cease on the data buses of electric vehicle 100 (e.g., a “sleep” state of the respective data buses of electric vehicle 100). The nonvolatile memory of dongle 120 may also retain any or all of the above data in the event that power is removed from dongle 120, say, via a “sleep” state of electric vehicle 100 or removal of dongle 120 from connection with electric vehicle 100.

Bluetooth technology, or other short-range wireless communications, that may be in dongle 120 enables charger 110 to detect or estimate the distance from dongle 120 to charger 110. This may be done by charger 110 detecting signal strength (i.e., received signal strength indicator) of the short-range wireless signal from dongle 120. Time-of-flight of the signals between dongle 120 and charger 110 may also be used to detect or estimate the distance of dongle 120 to charger 110. Dongle 120 may also contain low-frequency technology that allows charger 110 to detect or estimate the distance between dongle 120 and charger 110 through measurement of the phase of signals between dongle 120 and charger 110. Further yet, dongle 120 and charger 110 may either or each contain componentry for radar, such as ultra-wide band (UWB) radar, in order to sense the proximity between dongle 120 and charger 110. Knowing the distance between dongle 120 and charger 110 may allow charger 110 to understand that electric vehicle 100 is approaching charger 110 and to prepare for the charging event. For instance, if electric vehicle 100 (or dongle 120) approaches more closely than a predetermined distance to charger 110, charger 110 may seek instructions from the driver of electric vehicle 100, such as through smartphone 130, for charging of electric vehicle 100.

The driver of electric vehicle 100 (who may also be referred to in this disclosure as the user of electric vehicle 100), or another user of the app may, through an app on smartphone 130, indicate to charger 110 the number of miles of range the driver wishes to have available as a result of charging electric vehicle 100. This may be done by inputting a regular standing schedule. For example, the driver may indicate to charger 110 via the app that the driver would like 100 miles to be available on weekdays (and more specifically, possibly on weekdays at a specific time, say, 7 a. m.) and 150 miles available on weekend days. Or, for any specific day, the driver can indicate the number of miles desired for that day; if the driver knows, say, that she or he is going on a long distance drive of 250 miles on a particular upcoming day beginning at 9:00 a. m., the driver may so inform charger 110 via the app on smartphone 130.

Charger 110, once it knows that amount of driving range elected by the driver (that is, a threshold vehicle driving range or, alternatively, a threshold level of charge in the traction batteries of electric vehicle 100) and when that driving range is needed (that is, a deadline for charging the traction batteries of electric vehicle 100), may supervise charging of electric vehicle 100 appropriately. Charger 110 may, at the beginning of the charging event, know the amount of range (e.g., in miles or kilometers) already available on electric vehicle 100, as data available through the interface between dongle 120 and the respective data buses on vehicle 100 from the onboard charging system of electric vehicle 100. Alternatively, charger 110 may begin with the state of charge (in percent of full charge) of the traction batteries and infer the driving range that this state of charge represents. This inference may be made because charger 110 knows the odometer reading of electric vehicle 100 and charger 110 has supervised previous charging events of electric vehicle 100. Charger 110 may then know from experience that a state of charge of, say, 20% in absolute terms (or a difference of state of charge of 20%, say, between 50% state of charge and 70% state of charge) represents approximately, say 55 miles of range. Charger 110 may make a similar inference if state of charge of the traction batteries of electric vehicle 100 is represented in units of energy (e.g., kilowatt-hours) or stored charge (e.g., amp-hours). That is, one or more controllers that operate charger 110 may be programmed to infer a relationship between driving range of electric vehicle 100 and state of charge of its traction batteries based on past charging experience of electric vehicle 100.

Charger 110 may also know from past experience and/or from the charging capacity of the onboard charger on electric vehicle 100 (say, 4 KW, 8 kW, 11 kW, etc.), which charging capacity may be known to dongle 120 via dongle's connection with electric vehicle 100, the time rate at which electric vehicle 100 will charge. (The charging capacity of the onboard charger may be available in data extracted from electric vehicle 100 by dongle 120, or it may be input by the driver of electric vehicle 100 into the app on smartphone 130.)

Knowing, then, the driver-elected driving range (and targeting that range or a corresponding inferred target state of charge or a corresponding inferred target amount of stored energy or amount of stored charge) and a rate at which electric vehicle 100 charges, charger 110 may stage the charging to take place at the most cost-effective times while still reaching the driver-elected range by the driver-elected deadline. That is, the electric utility may have time-variable electric rates, for instance lower electric rates at off-peak times of the day or night.

As an enhancement, charger 110 may know the state of health of the traction batteries of electric vehicle 100 as data acquired by dongle 120 and provided to charger 110 via data link 160. Charger 110 may adjust its charging algorithm with that knowledge, which informs about the rate at which the traction batteries of electric vehicle 100 are capable of being charged, to help assure that the traction batteries are charged to the driver-elected level by the driver-elected day and time. Charger 110 may learn from experience with charging electric vehicle 100 the effect that a degrading state of health has over time on the rate at which the traction batteries of electric vehicle 100 charge. That knowledge may be further used in the process of staging or scheduling charging of the traction batteries of electric vehicle 100 at cost-effective times while still meeting the driver-elected range by the driver-elected deadline for the charging event.

As an enhancement, whether or not electric vehicle 100 is authorized for charging by charger 110 may be tested by charger 110 prior to charging, given that dongle 120 knows the VIN of electric vehicle 100. Charger 110 may proceed with charging only if electric vehicle 100, as represented by the VIN thereof, is authorized to use charger 110. This may be of particular utility if charger 110 is a commercial charger with which the driver of electric vehicle 100 has a subscription for charging of electric vehicle 100, as opposed to a charger in the private garage of the driver of electric vehicle 100. The VIN of electric vehicle 100 may then also be used for invoicing to the driver's account for charging of electric vehicle 100. Because VIN of electric vehicle 100 may be available in nonvolatile memory of dongle 120, these authorization and invoicing functions may be available even if electric vehicle 100 is capable of charging while its data buses that would otherwise communicate with dongle 120 are “asleep”.

As a further enhancement, charger 110 may test the identity of dongle 120 via data link 160 at the beginning of a charge event; dongle 120 may be assigned a unique digital identifier. This functionality may have utility if the person who owns dongle 120 has an account with the operator of charger 110 that is not limited to use with only one vehicle. In that event, the driver of electric vehicle 100, who may also own other vehicles, may carry dongle 120 to such other vehicles and charge them as well. Alternatively, the owner of dongle 120 may lend dongle 120 to others, such as friends or family members. Charger 110 would, under this dongle-based authorization methodology, charge the vehicle of anyone who has dongle 120 plugged into such vehicle and may invoice for the charging event via an account maintained by the owner of dongle 120.

The driver of electric vehicle 100 may receive a notification from charger 110 via the app on smartphone 130 when electric vehicle 100 is plugged into charger 110. Alternatively, the driver of electric vehicle 100 may receive such a notification when electric vehicle 100 is sensed by charger 110 to be near or approaching charger 110. That is, charger 110 may seek charging instructions from the driver when electric vehicle 100 is near or approaching charger 110, which may include when electric vehicle 100 approaches more closely than a predetermined distance to charger 110. Upon such notification, the driver of electric vehicle 100 may input any desired parameters (such as the number of miles of range desired by a particular day and time). Alternatively, the driver of electric vehicle 100 may elect for charging as per previously selected parameters (e.g., at least 150 miles of range by 7 a. m. every weekday) or may simply allow charger 110 to begin charging without such constraints and without regard to the electricity rates for the upcoming charging period and charge as quickly as possible until electric vehicle 100 is fully charged.

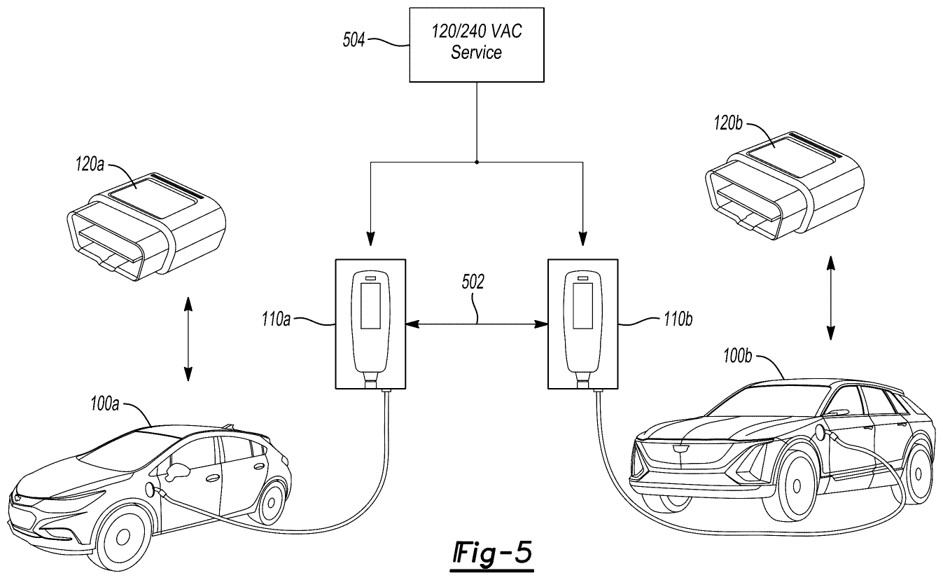

Referring additionally to FIG. 5, a system according to this disclosure may also be used in the event that multiple chargers 110a and 110b are installed on a single electrical service 504 (or common circuit). This may be the case, for instance, for a family that owns two electric vehicles 100a and 100b that the family may wish to charge at the same time, but the family only wishes to install one electrical service 504. Here, electric vehicle 100a may be connected with charger 110a and electric vehicle 100b may be connected with charger 110b and both vehicles set up with the app on smartphone 130. Charger 110a and charger 110b may communicate with one another via a wireless communication channel 502, which may be by Bluetooth technology, WiFi, or other appropriate communication. Dongle 120a may be removably connected within electric vehicle 100a and dongle 120b may be removably connected within electric vehicle 100b. It should be noted that the structure and circuitry of charger 110a and charger 110b may be similar or identical to one another (and to charger 110) and each of charger 110a and 110b may be interconnected with the Internet and other resources illustrated in FIG. 1, such as back office server 140 and power company server 150. The structure and circuitry of dongle 120a and dongle 120b may also be similar or identical to one another and to dongle 120.

The system disclosed herein provides substantial utility in this multiple-vehicle, multiple-charger scenario. Firstly, the coordination of chargers 110a and 110b can be done to assure that chargers 110a and 110b do not overload the electrical service 504 that commonly feeds chargers 110a and 110b. This may be the overriding priority in any algorithm that coordinates the control of chargers 110a and 110b.

Additionally, then, the user of an app on smartphone 130 may input the number of miles needed for electric vehicle 100a and electric vehicle 100b by given date and time deadlines. Chargers 110a and 110b may coordinate such that both electric vehicle 100a and electric vehicle 100b are charged to their respective user- or driver-desired ranges by the user- or driver-desired deadlines. To the extent that there is sufficient time to charge both electric vehicle 100a and electric vehicle 100b accordingly, chargers 110a and 110b may then, with the knowledge of time-variable electricity rates of the electrical utility over the upcoming time period as provided by power company server 150, stage the charging so that it occurs as much as possible at the most cost-effective times.

However, it is possible that the desired charging of vehicles 100a and 100b is such that there is not time to charge both electric vehicle 100a to its driver-elected range by its driver-elected charging deadline and electric vehicle 100b to its driver-elected range by its driver-elected charging deadline. Then, the algorithms controlling charger 110a and charger 110b may prioritize or assure charging of one of electric vehicle 100a and electric vehicle 100b to its driver-elected charging level before charging the other of electric vehicle 100a and electric vehicle 100b; which electric vehicle 100a or electric vehicle 100b is prioritized may be selected via the user of the app on smartphone 130. Or charger 110a and charger 110b may assure that a minimum amount or threshold of driving range (or alternatively, state of charge) is on both electric vehicle 100a and electric vehicle 100b, say 50 miles for instance, before then charging the prioritized electric vehicle 100a or electric vehicle 100b further; that minimum amount or threshold may be predetermined or may be selected by the user of the app and may be different for electric vehicle 100a and electric vehicle 100b. As discussed above in connection with the single-vehicle charging scenario, charger 110a and charger 110b may estimate range by percentage state of charge of the traction batteries of electric vehicle 100a and electric vehicle 100b or the amount of stored energy or amount of stored charge in the traction batteries of electric vehicle 100a and electric vehicle 100b.

The algorithm coordinating charger 110a and charger 110b may be resident on either charger 110a or charger 110b, or it may be distributed between charger 110a and charger 110b, with coordination of the distributed computing accomplished by data sharing between charger 110a and 110b via wireless communication channel 502. The algorithm may also reside, in whole or in part, in the cloud.

A significant advantage of a charging system as disclosed herein is that the charger(s) may know which vehicle(s) they are charging and have access to extensive data about the vehicles, their states, and their charging histories. This may allow more intelligent charging to be accomplished than simply via a charger-vehicle interface such as SAE J1772, NACS, or similar interfaces.

Knowing the distance between a dongle and a charger may help the charger identify which vehicle is under charge, where there may be multiple vehicles within short range radiofrequency range (that is, communication range of a dongle) of the charger. For example, consider the scenario involving two electric vehicles, electric vehicle 100a and electric vehicle 100b, two chargers 110a and 110b, and two dongles 120a and 120b. By knowing the distance of the electric vehicle under charge to charger 110a, say, may be able to know which of electric vehicle 100a and electric vehicle 100b is connected to and being charged by charger 110a. This will enhance the ability of charger 110a (and/or back office 140) to learn the charging history of electric vehicle 100a and electric vehicle 100b and keep statistics (cost of charging and energy used, for example) about electric vehicle 100a and electric vehicle 100b. The above scenario for determining which electric vehicle is under charge may be particularly useful when an electric vehicle is capable of being charged while its data bus(es) are “asleep” and therefore not communicating real-time data via a respective dongle.

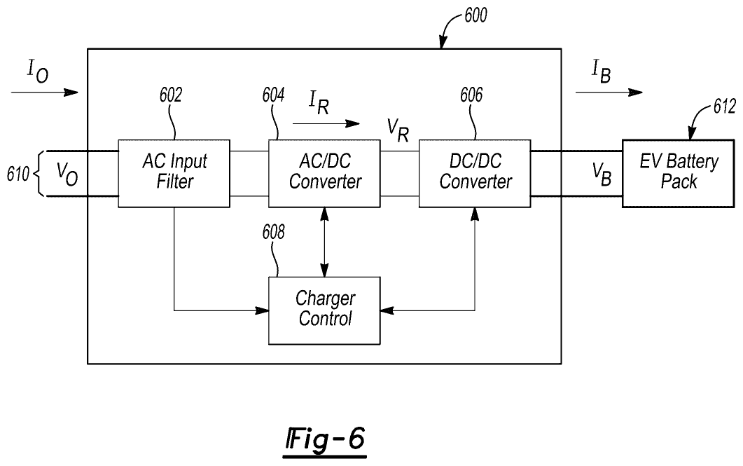

Instead of operating with a Level 1 or Level 2 charger, the system of this disclosure may operate with a Level 3 charger that may output DC (direct current) directly to the vehicle's batteries. Referring to FIG. 6, a Level 3 bidirectional charger or DC fast charger 600 is shown. Charger 600 may include an AC (alternating current) input filter 602 coupled to the AC power input 610 to the charger. Charger 600 may also include an AC/DC converter 604 to convert the input alternating current to direct current. Charger 600 may also include a DC/DC converter 606 to change the voltage level to an appropriate level VB to match the voltage of the battery pack 612. Control of the charger may be carried out by charger control 608, which may be microprocessor based and contain the microcomputer resources appropriate for controlling charger 600. Charger 600 may be directional, that is, able to take power from battery pack 612 and provide it as an output from AC power input 610.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

What is claimed is:

1. A method for operating a vehicle charging system, the method comprising:
providing data from an electric vehicle through a wireless communications device removably installed in the electric vehicle;
wirelessly receiving the data by an electric vehicle charger; and
managing, by the electric vehicle charger and using the data, provision of charging current from the electric vehicle charger for traction batteries of the electric vehicle.

2. A method for operating a vehicle charging system as recited in claim 1, wherein the wireless communications device is removably installed in a diagnostic connector of the electric vehicle.

3. A method of operating a vehicle charging system as recited in claim 1, wherein the wireless communications device is removably installed in a diagnostic connector of the electric vehicle that is compliant with SAE Recommended Practice J1962.

4. A method for operating a vehicle charging system as recited in claim 1, wherein:
the data includes identification information that uniquely identifies the electric vehicle; and
managing provision of charging current from the electric vehicle charger for traction batteries of the electric vehicle comprises using the identification information to authorize charging of the electric vehicle.

5. A method for operating a vehicle charging system as recited in claim 1, further comprising storing the data in nonvolatile memory of the wireless communications device.

6. A method for operating a vehicle charging system as recited in claim 1, wherein the data includes state of charge of the traction batteries or driving range of the electric vehicle currently available from stored electrical energy in the traction batteries.

7. A method for operating a vehicle charging system as recited in claim 1, wherein managing provision of charging current from the electric vehicle charger for traction batteries of the electric vehicle comprises providing charging current to the electric vehicle to reach a threshold level of charge or threshold electric vehicle driving range in the traction batteries by a deadline provided by a user of the electric vehicle.

8. A method for operating a vehicle charging system as recited in claim 1, wherein managing provision of charging current from the electric vehicle charger for traction batteries of the electric vehicle comprises providing charging current to the electric vehicle to reach a threshold level of charge or threshold electric vehicle driving range in the traction batteries by a deadline provided by a user of the electric vehicle and in view of time-variable electric rates of an electric utility supplying electric power to the electric vehicle charger.

9. A method for operating a vehicle charging system as recited in claim 1, further comprising:
providing, by the wireless communications device, a unique identifier of the wireless communications device to the electric vehicle charger; and
enabling charging current to be provided from the electric vehicle charger only if the wireless communications device is authorized to use the electric vehicle charger.

10. A method for operating a vehicle charging system as recited in claim 1, further comprising wirelessly sensing a proximity of the wireless communications device to the electric vehicle charger.

11. A method for operating a vehicle charging system as recited in claim 10, further comprising seeking charging instructions from a user of the electric vehicle when the wireless communications device approaches more closely than a predetermined distance to the electric vehicle charger.

12. A method for operating a vehicle charging system, the method comprising:
providing first data from a first electric vehicle through a first wireless communications device removably installed in the first electric vehicle;
providing second data from a second electric vehicle through a second wireless communications device removably installed in the second electric vehicle;
wirelessly receiving the first data by a first electric vehicle charger;
wirelessly receiving the second data by a second electric vehicle charger; and
managing, by the first electric vehicle charger and the second electric vehicle charger and using the first data and second data, provision of charging current for first traction batteries of the first electric vehicle and second traction batteries of the second electric vehicle.

13. A method for operating a vehicle charging system as recited in claim 12, wherein:
the first electric vehicle charger and the second electric vehicle charger are supplied by a common electrical service; and
the method further comprises managing a total charging current from the first electric vehicle charger and the second electric vehicle charger so that the total charging current does not exceed a capacity of an electrical service supplying both the first electric vehicle charger and the second electric vehicle charger.

14. A method for operating a vehicle charging system as recited in claim 12, wherein managing provision of charging current for first traction batteries of the first electric vehicle and second traction batteries of the second electric vehicle comprises assuring that the first traction batteries have at least a threshold level of charge or a threshold electric vehicle driving range before charging the second traction batteries.

15. A method for operating a vehicle charging system as recited in claim 12, wherein managing provision of charging current for first traction batteries of the first electric vehicle and second traction batteries of the second electric vehicle comprises:
assuring that the first traction batteries have at least a first threshold level of charge or a first threshold electric vehicle driving range and the second traction batteries have at least a second threshold level of charge or a second threshold electric vehicle driving range; and
thereafter, prioritizing charging the first traction batteries to at least a third threshold level of charge level or third threshold electric vehicle driving range before charging the second traction batteries.

16. An electric vehicle charging system comprising one or more controllers collectively programmed with the following instructions:
provide data from an electric vehicle through a wireless communications device installed in the electric vehicle;
wirelessly receive the data by an electric vehicle charger; and
manage, by the electric vehicle charger and using the data, provision of charging current from the electric vehicle charger for traction batteries of the electric vehicle.

17. An electric vehicle charging system of claim 16, wherein the one or more controllers are further collectively programmed with the following instructions:
provide second data from a second electric vehicle through a second wireless communications device installed in the second electric vehicle;
wirelessly receive the second data by a second electric vehicle charger; and
manage, by the electric vehicle charger and the second electric vehicle charger and using the data and the second data, provision of charging current for the traction batteries of the electric vehicle and for second traction batteries of the second electric vehicle.

18. An electric vehicle charging system as recited in claim 17, wherein the one or more controllers are further collectively programmed to charge the electric vehicle to a first state of charge or a first vehicle driving range before charging the second electric vehicle.

19. An electric vehicle charging system as recited in claim 17, wherein the one or more controllers are further collectively programmed to:
charge the electric vehicle and the second electric vehicle each to threshold levels of state of charge or vehicle driving range; and
thereafter, continue to charge the electric vehicle.

20. An electric vehicle charging system as recited in claim 16, wherein the one or more controllers are further collectively programmed to infer a relationship between driving range of the electric vehicle and state of charge of the traction batteries based on past charging experience of the electric vehicle.
